(19) United States
(12) Patent Application Publication
(10) Pub. No.: US 2005/0157703 A1
(43) Pub. Date: Jul. 21, 2005

(54) xDSL modem of PPPoE method including DHCP spoofing server and mehtod of connecting to internet using the same

(76) Inventor: Eung-Seok Roh, Suwon-si (KR)

Correspondence Address: Robert E. Bushnell;Suite 300, 1522 K Street, N.W., Washington, DC, 20005, US

(21) Appl. No.: 11/002,272

(22) Filed: Dec. 3, 2004

(30) Foreign Application Priority Data
Jan. 20, 2004 (KR) 2004-4376

(51) Int. Cl. H04L 12/66

(52) U.S. Cl. 370/352; 370/493

(57) ABSTRACT

A digital subscriber line modem of a PPPoE method has a dynamic host configuration protocol (DHCP) spoofing server which can make it possible to connect to said Internet by booting the client terminal, without installing a PPPoE driver in a client terminal, and a system thereof, and a method of connecting to the Internet using the same. An Internet connection system for performing Internet connection through a digital subscriber line (xDSL) modem includes at least one client terminal connecting to the XDSL modem through a transmission control protocol/Internet protocol (TCP/IP) connection; a network access server (NAS) connecting to the xDSL modem through a PPP connection; and the XDSL modem including a dynamic host configuration protocol (DHCP) spoofing server module for performing the same function as a dynamic host configuration protocol (DHCP) server, a PPP module for providing the point-to-point protocol (PPP) connection with a network access server (NAS), and a PPP over Ethernet (PPPoE) module for connecting to the client terminal through an Ethernet protocol and supporting the PPP connection with the network access server (NAS).

### CLAIM OF PRIORITY

This application makes reference to, incorporates the same herein, and claims all benefits accruing under 35 U.S.C. §119 from an application for xDSL MODEM AND SYSTEM INCLUDING DHCP SPOOFING SERVER, AND PPPoE METHOD FOR CONNECTING INTERNET USING THE SAME earlier filed in the Korean Intellectual Property Office on 20 Jan. 2004 and there duly assigned Serial No. 2004-4376.

### BACKGROUND OF THE INVENTION

1. Field of the Invention

The present invention relates to a network which provides Internet connection by using a point-to-point protocol (PPP) method. More particularly, the present invention relates to a digital subscriber line modem of a PPPoE method having a PPPoE module, a PPP module, and a dynamic host configuration protocol (DHCP) spoofing server to connect to the Internet at the same time as a client terminal is booted, without installing an Internet connection program in the client terminal, in order to connect to the Internet through a point-to-point protocol over Ethernet (PPPoE) mode, and a system thereof, and a method of connecting to the Internet using the same.

2. Description of the Related Art

A digital subscriber line (hereinafter referred to as “xDSL”) connects a digital network at a subscriber site to a predetermined Internet service provider (ISP) through an analog telephone line. The xDSL provides a plurality of independent channels which are used to transmit an audio telephone signal such as a voice signal, a facsimile signal, or the like, and thus thanks to the xDSL, high-speed data communication is possible and also the audio telephone signal and the high-speed data communication can be simultaneously transceived through a traditional telephone line.

Such an xDSL allocates a first frequency range of 0 KHz (kilohertz) to 4 KHz to an analog audio signal (POTS: plain old telephone service) and a second frequency range of 4 KHz to 2.2 KHz to a data communication.

The audio telephone signal is not transmitted together with the data communication in a typical modem, whereas the xDSL makes it possible for the audio telephone signal to be transmitted together with the high-speed data communication. This is because the transmission of the audio telephone signal occupies a low frequency band, whereas the high-speed data communication occupies a high frequency band.

Among the xDSLs, an asymmetric digital subscriber line (ADSL) is the most popular that provides a data exchange speed between a telephone office and a subscriber differently according to an upstream link and a downstream link.

FIG. 1 is a schematic diagram illustrating a network including an XDSL of a typical point-to-point protocol (PPP) method.

Referring to FIG. 1, two different networks exist between a network access server 4 (NAS: see RFC (request for comments) 2881) and a client PC (personal computer) 1.

A public network (global IP address: 200.10.10.1) exists between the NAS 4 and the xDSL modem 2, and a private network (local IP address: 200.10.10.100) exists between the client PC 1 and the xDSL modem 2.

An IP network address converter converts a local IP address of the client PC 1 to a global IP (Internet protocol) address of the xDSL modem 2. The local IP address and the gateway IP address are brought to the xDSL modem 2 and are set as information on a wide area network (WAN) port after the xDSL modem 2 is connected to the NAS 4 through a PPP (point-to-point protocol) layer using a PPP method.

A user should input one local IP address, a subnet mask, a gateway IP address (global IP address), and a domain name service server address in the client PC 1 as IP configuration information.

When the client PC 1 communicates with the NAS 4, the IP (Internet protocol) address has a path determined by the IP network address converter of the xDSL modem 2, and is converted to a global IP address used to connect to the NAS 4 through a digital subscriber line access multiplexer (DSLAM) 3.

The NAS 4 is an ISP (Internet service provider) server which provides an Internet service to a subscriber.

That is, in order to get Internet connection, the user first connects to the NAS 4 through the client PC 1 using the PPP method and finds out IP configuration information including an IP address.

In other words, the conventional xDSL modem 2 just functions as a bridge between a public network (ATM (asynchronous transfer mode) network) and a private network (Ethernet network). Therefore, the PPP module should be installed in the client PC 1 so that the client PC 1 can communicate with the NAS 4 using the PPP method. In addition, the PPPoE module is needed because the client PC 1 should communicate with the xDSL modem 2 on the Ethernet. That is, the NAS 4 and the client PC 1 are connected through a PPP network and communicate through the PPPoE.

For the sake of this, in the client PC 1, Internet connection software should be installed 11 including a PPPoE driver, which can communicate with the NAS 4 using the PPP method in advance.

Next, after an ID (identification) and a password of the user are inputted, the IP (Internet protocol) configuration information being received through the PPP connection of the NAS 4 should be set in the client PC 1.

Therefore, an Internet connection service using the conventional xDSL modem has the following problems.

1. The client PC needs a PPPoE driver, and thus Internet connection software including the PPPoE driver should be installed in the client PC.

2. An ultimate customer should pay a fee for the Internet connection software.

3. The Internet connection software configuration files and shared files may be deleted by a user's mistake, and thus in this case, the PPPoE driver should be reinstalled.

4. There is a possibility that the shared files used in the Internet connection software may conflict with other applications, and thus in this case this becomes a burden for A/S to a communication carrier.

5. The client PC should allocate separate resources for the Internet connection software and should load the Internet connection software whenever connected to the Internet.

6. A user should input an ID (identification) and a password to connect to the Internet, and thus the ID and the password can be exposed to other persons.

### SUMMARY OF THE INVENTION

It is therefore, an objective of the present invention to provide a digital subscriber line modem of a PPPoE method having a DHCP spoofing server which can make it possible to connect to the Internet by turning on the client terminal, without installing a PPPoE driver in a client terminal, and a system thereof, and a method of connecting to the Internet using the same.

It is another objective to provide a digital subscriber line modem with a PPPoE module, the PPP module and the DHCP spoofing server, that is easy to implement, efficient and cost effective.

It is yet another objective to provide a communication carrier that does not need to perform maintenance for the Internet connection program, and thus reducing service cost.

It is still another object to provide a digital subscriber line modem of a PPPoE method that increases security by having the ID (identification) and the password stored in the xDSL modem, accommodating the user to connect to the Internet without inputting the ID and the password, and thus there is no possibility that the ID and password are exposed to other persons.

It is another object to provide a digital subscriber line modem of a PPPoE method that accommodates the communication carrier to avoid having to develop an Internet connection program and not needing to perform maintenance for the Internet connection program, thus reducing service cost.

In order to achieve the above and other objectives, the present invention provides a method of connecting to Internet using a digital subscriber line modem of a point-to-point protocol over Ethernet (PPPoE) method which supports a PPPoE connection between a client terminal and a network access server (NAS), including: connecting between the digital subscriber line modem and the NAS through a PPP method and connecting between the digital subscriber line modem and the client terminal through a transmission control protocol/Internet protocol (TCP/IP) method; at the client terminal, obtaining IP configuration information from the NAS through the digital subscriber line modem; and at the digital subscriber line modem, bridging a PPP network and a TCP/IP network so that an IP packet is transmitted between the NAS and the client terminal.

The method further includes returning to the NAS, an IP address which is allocated when the client terminal connects to the Internet.

Obtaining the IP configuration information includes: executing a DHCP client mounted on the client terminal to drive a DHCP spoofing server installed in the digital subscriber line modem; at the DHCP spoofing server, executing a discovery stage to obtain the IP configuration information from the NAS; obtaining the IP configuration information by the discovery stage; and at the client terminal, setting the obtained IP configuration information in a corresponding file.

Driving the DHCP spoofing server is performed through a step of, at the DHCP client installed in the client terminal, broadcasting a message to obtain the IP configuration information allocated from the DHCP server.

Executing the discovery stage includes: executing a PPP session stage with the NAS; executing a PPP IPCP to obtain the IP configuration information from the NAS when the PPP session stage is performed and a PPP link is established; and obtaining the IP configuration information from the NAS by a IPCP stage.

The method further includes, after the IP configuration information to be used by the client terminal is obtained by obtaining the IP configuration information by the discovery stage, transmitting to a DHCP message processor of the DHCP spoofing server; at the DHCP message processor, producing a response message for an IP configuration information request message broadcasted by the client terminal and transmitting the message to a header producing unit; transmitting to an Ethernet driver in the form of a frame having an IP header and an Ethernet header produced in the header producing unit; at the client terminal, transmitting the response message for the IP configuration information request message to the DHCP message processor; and at the DHCP message processor, loading to a confirm message for the IP configuration information response message and transmitting to the client terminal.

The IP configuration information includes an IP address, a gateway address, a subnet mask, a domain name system (DNS) server IP address, a lease time, and a lease renewal time.

The subnet mask is produced by combining the gateway IP address and a global IP address.

The method further includes storing a MAC (media access control) address of the client terminal, which is to be used when a DHCPOFFER message is transmitted, by the DHCP message processor which has received a message broadcasted from the DHCP client.

The discovery stage step of a PPPoE layer includes a PPPoE active discovery initiation (PADI) step, a PPPoE active discovery offer (PADO) step, a PPPoE active discovery request (PADR) step, and a PPPoE active discovery session confirmation (PADS) step.

The PPP session step includes: a PPP LCP step of executing a link with a PPP layer of the NAS; an authentication step of performing a user authentication process; and an IPCP step of performing a process for obtaining the IP configuration information which is to be used by the client terminal, after the authentication is completed.

The authentication step is one of a password authentication protocol (PAP), a challenge-handshake authentication protocol (CHAP), and an extensible authentication protocol (EAP).

The PPP session step includes a PPP header addition and deletion (PHAD) step of producing a PPP header when a frame is transmitted to a PPP layer from an Ethernet layer, and deleting the PPP header when the frame is transmitted to the Ethernet layer from the PPP layer.

Bridging the PPP network and the TCP/IP (transmission control protocol/Internet protocol) network includes: when a frame is transmitted to the NAS from the client terminal through the digital subscriber line modem, the frame having an Ethernet header added to a packet corresponding to actual data is transmitted to a PPP layer through a TCP/IP driver; transmitting the frame having a PPP header added thereto in the PPP layer to a PPPoE layer; and transmitting the frame having a PPPoE header added thereto in the PPPoE layer to a physical layer, wherein the frame includes a payload corresponding to the actual data, the PPP header, the PPPoE header, and the Ethernet header.

Bridging the PPP network and the TCP/IP network includes: when a frame is transmitted to the client terminal from the NAS through the digital subscriber line modem, transmitting the frame having a payload corresponding to actual data, a PPP header, a PPPoE header, and an Ethernet header to a PPPoE layer; deleting the PPPoE header from the frame in a PPPoE module and transmitting the frame having the payload corresponding to the actual data, the PPP header, and the Ethernet header to a PPP layer; and deleting the PPP header from the frame in the PPP layer and transmitting to the Ethernet layer, wherein a packet is transmitted in the form of the payload corresponding to the actual data and the Ethernet header.

In a frame format in the PPPoE layer, a type field of the Ethernet header is set to represent that the payload is a PPPoE, a code field of the PPPoE header is “0x00”, a session ID field is set to a value allocated in a discovery process, and a length field is set to represent a PPPoE payload length.

Returning the IP address to the NAS includes: when a DHCP release message is received from the client terminal or a DHCP spoofing server of the digital subscriber line modem does not receive a renewal request message from the client terminal within a lease time allocated to the client terminal, at the DHCP spoofing server, informing an LCP stage of a PPP layer of an IP address return; at the PPP LCP stage, transmitting a termination request message to a PPPoE layer; at the PPPoE layer, transmitting the termination request message to the NAS through a physical layer; and at the NAS, transmitting a termination acknowledge message to the digital subscriber line modem to release an established PPP link.

When the DHCP release message is received from the client terminal, this means that the client terminal is turned off or the user deletes the IP configuration information so that a LAN port of the client terminal becomes inactivated.

The method further includes when the termination request message is transmitted to the NAS, at the PPP LCP stage, informing the PPPoE layer of release of the PPP link to cut off the PPPoE session; and at the PPPoE layer, transmitting a PPPoE active discovery termination (PADT) packet to the NAS to terminate the PPP session.

The present invention further provides a digital subscriber line modem, including: a DHCP spoofing server module for performing the same function as a dynamic host configuration protocol (DHCP) server; a PPP module for providing a point-to-point protocol (PPP) connection with a network access server (NAS); and a PPP over Ethernet (PPPoE) module for connecting to a client terminal through an Ethernet protocol and supporting the PPP connection with the NAS.

When the client terminal is booted, a TCP/IP connection is established between the client terminal and an xDSL modem and a PPP connection is established between the xDSL modem and the NAS such that the xDSL modem connects to the NAS through a PPP method to obtain an IP configuration information and then provides the obtained IP configuration information to the client terminal through a DHCP message.

The digital subscriber line modem further includes a PPP header addition/deletion (PHAD) unit which adds a PPP header to a data frame when an IP packet is transmitted to the NAS from the client terminal, and deletes the PPP header of the data frame when the IP packet is transmitted to the client terminal from the NAS.

A subnet mask is produced from a gateway IP address and a global IP address among the IP configuration information obtained from the NAS.

When an ID and a password of a client terminal user are set by an installer, the ID and the password are stored and are automatically inputted when the client terminal tries to connect to the Internet.

The ID and the password are set and changed by the user.

The present invention further provides an Internet connection system for performing an Internet connection through a digital subscriber line (xDSL) modem having a PPPoE spoofing function, including: at least one client terminal connecting to the xDSL modem through a TCP/IP connection; a NAS connecting to the xDSL modem through a PPP connection; and the xDSL modem including a DHCP spoofing server module for performing the same function as a dynamic host configuration protocol (DHCP) server, a PPP module for providing the point-to-point protocol (PPP) connection with a network access server (NAS), and a PPP over Ethernet (PPPoE) module for connecting to the client terminal through an Ethernet protocol and supporting the PPP connection with the NAS.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram illustrating a network including an xDSL modem of a typical point-to-point protocol (PPP) method;

FIG. 2 is a schematic diagram illustrating a network including a digital subscriber line modem according to an embodiment of the present invention;

FIG. 3 is a schematic diagram illustrating a protocol stack of respective parts of the network comprised of the digital subscriber line modem of a typical point-to-point method;

FIG. 4 is a schematic diagram illustrating a protocol stack of respective parts of a network composed of a digital subscriber line modem of according to an embodiment of the present invention;

FIG. 5 is a diagram illustrating a protocol stack and a data stream of an xDSL modem according to an embodiment of the present invention;

FIG. 6 is a diagram illustrating a DHCP message stream between a client PC and a DHCP spoofing server;

FIG. 7a is a diagram illustrating a frame format in a PPPoE layer;

FIG. 7b is a diagram illustrating a frame format in a PPP layer; and

FIG. 7c is a diagram illustrating a frame format in an Ethernet layer.

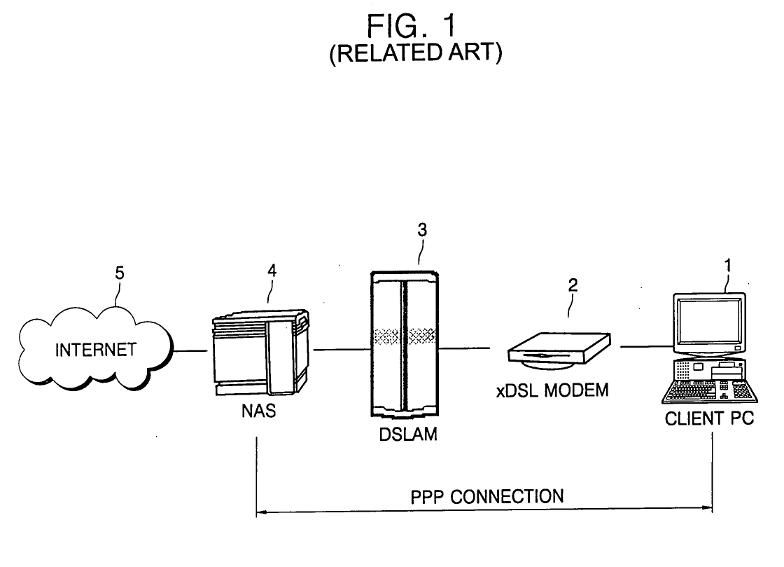

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

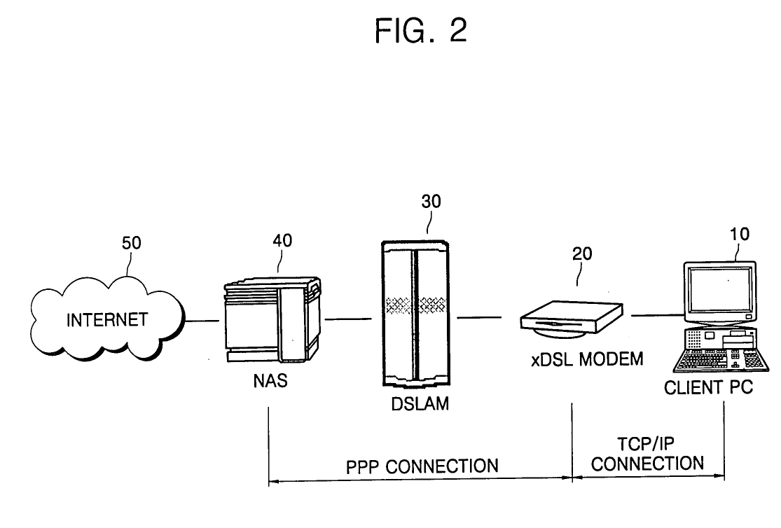

FIG. 2 is a schematic diagram illustrating a network including a digital subscriber line modem according to an embodiment of the present invention.

Referring to FIG. 2, a TCP/IP connection is established between a client terminal (PC) 10 and an xDSL modem 20, and a PPP connection is established between the xDSL modem 20 and a NAS 40 through a DSLAM 30.

In the embodiment of the present invention, a personal computer (PC) is used as an example of the client terminal 10 (a computer communication device such as a notebook computer and a PDA (personal digital assistant)).

When the client PC 10 performs the TCP/IP connection through the xDSL modem 20, the xDSL modem 20 requests the IP configuration information to the NAS 40 through the DSLAM 30. The IP configuration information that the xDSL modem 20 has got from the NAS 40 is transmitted to the client PC 10 and set in an IP configuration file of the client PC 10.

The client PC 10 is connected to an Internet 50 after the process described above.

The schematic configuration and process are explained below with reference to the attached drawings.

First, a protocol stack of a network to which PPPoE spoofing is applied according to the present invention is explained by comparison to the existing PPPoE network.

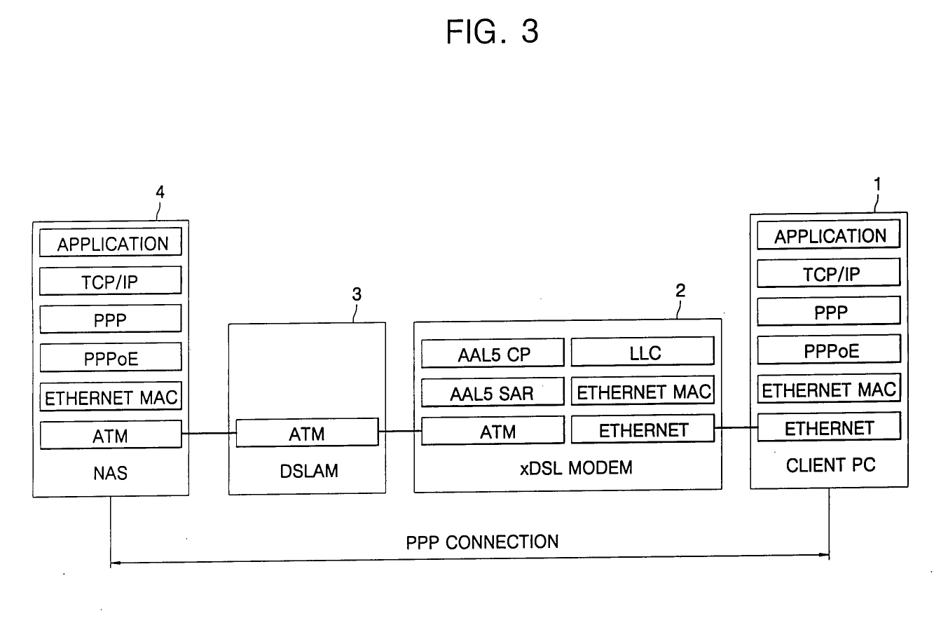

FIG. 3 is a schematic diagram illustrating a protocol stack of respective parts of a network composed of a digital subscriber line modem of a typical point-to-point method.

As shown in FIG. 3, a data frame transmitted from the client PC 1 has a PPP header added thereto in a PPP layer, a PPPoE header added thereto in a PPPoE layer and an Ethernet header added thereto in an Ethernet MAC layer, and then is transmitted to the xDSL modem 2 through an Ethernet layer.

The data frame is transmitted to the NAS 4 through a physical layer of the DSLAM 3 and is transmitted to a destination through the Internet.

Meanwhile, the protocol stack of the network comprised of the digital subscriber line modem in which a DHCP spoofing server is mounted according to an embodiment of the present invention is explained below.

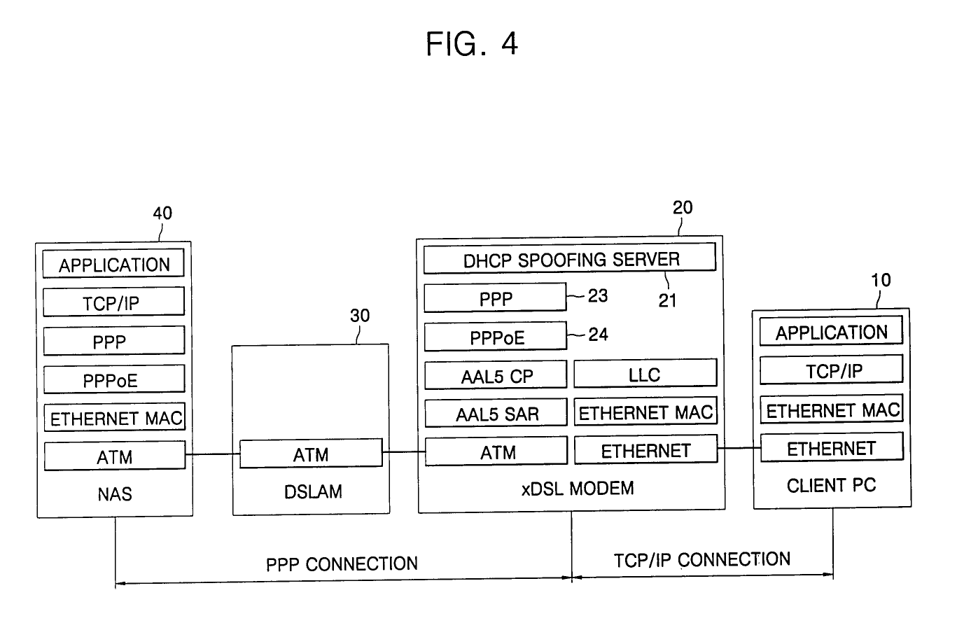

FIG. 4 is a schematic diagram illustrating a protocol stack of respective parts of a network composed of a digital subscriber line modem according to an embodiment of the present invention.

As shown in FIG. 4, a data frame transmitted from the client PC 10 has an Ethernet header added thereto in an Ethernet MAC layer and then is connected to the xDSL modem 20 through a TCP/IP connection.

At this time, the DHCP spoofing server 21 processes a DHCP message to obtain the IP configuration information from the NAS 40.

The obtained IP configuration information is set in the client PC 10, so that the TCP/IP connection is established between the XDSL modem 20 and the client PC 10, and a PPP connection is established between the xDSL modem 20 and the NAS 40.

When a link between the client PC 10 and the NAS 40 is established, an actual packet is transmitted in the form of data frame (PPP header, PPPoE header, Ethernet header, payload) which has a PPP header added thereto in a PPP layer of the xDSL modem 20 and a PPPoE header added thereto in a PPPoE layer.

An exemplary embodiment of the xDSL modem based on the protocol stack described above is explained below.

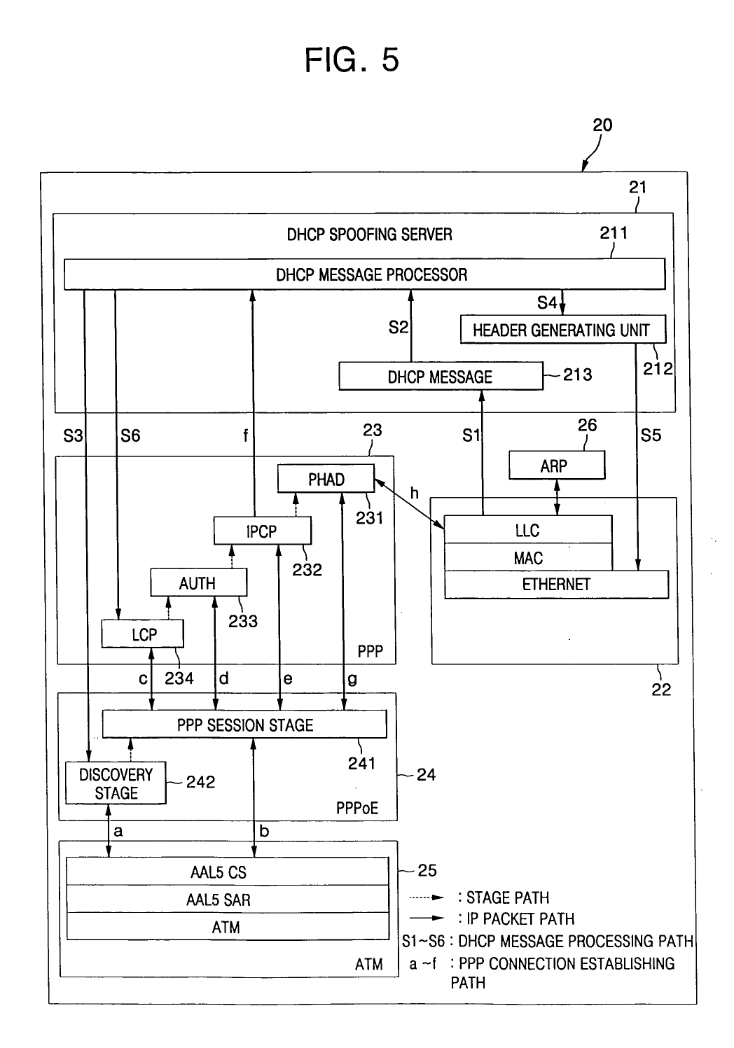

FIG. 5 is a diagram illustrating a protocol stack structure and a data stream of an xDSL modem according to an embodiment of the present invention.

The exemplary embodiment of the present invention is explained focusing on a process that the client PC is allocated an IP address.

The client PC 10 is allocated the IP address from the NAS 40 through the xDSL modem 20 when a LAN port of the client PC is changed from an inactive status to an active status, i.e., when the client PC 10 is booted or when a user forces the IP configuration information to be renewed.

At this time, the xDSL modem 20 acts to bridge the client PC 10 and the NAS 40 and thus does not need to have a global IP address. Merely, the xDSL modem 20 uses a local IP address to process the DHCP message received from the client PC 10.

A process that the xDSL modem 20 obtains the IP configuration information from the NAS 40 and provides it to the client PC when the client PC 10 is connected to a LAN is as follows.

The client PC operates a DHCP client contained in an operating system to broadcast a DHCPDISCOVER message in order to obtain the IP configuration information containing an IP address allocated from the DHCP server.

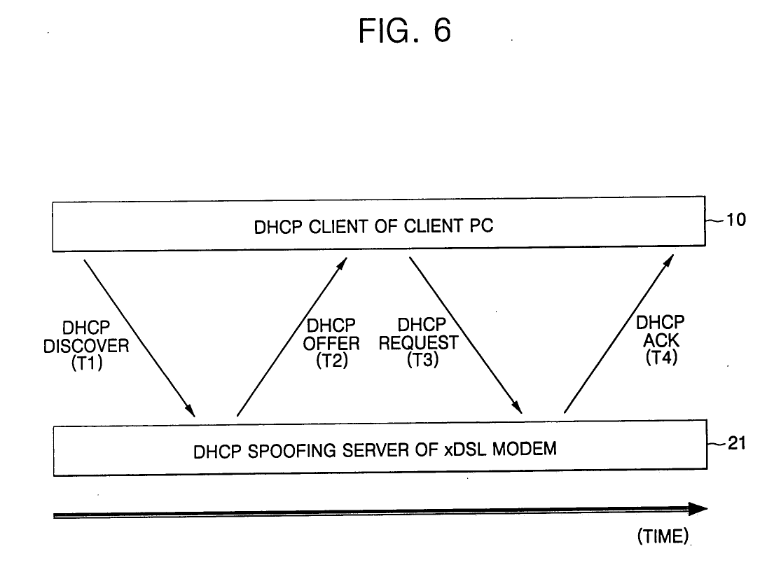

Hereinafter, a DHCP message processing process between the DHCP spoofing server 21 of the xDSL modem 20 and the DHCP client of the client PC 10 is explained with reference to FIG. 6.

FIG. 6 is a diagram illustrating a DHCP message stream between a client PC and a DHCP spoofing server.

As shown in FIG. 6, when the DHCPDISCOVER message is broadcasted from the client PC 10, the DHCP server (the DHCP spoofing server is used as the DHCP server in this application) which has received this message transmits a DHCPOFFER message, and when a DHCPREQUEST message which is a response signal is transmitted from the client PC 10, the DHCP spoofing server transmits a DHCPACK message which is an acknowledge signal.

This process is a typical DHCP IP address allocating process and follows RFC (request for comments) 2131.

A DHCP message, like S1 of FIG. 5, is transmitted to a DHCP message processor 211 by a DHCP message catcher 213 so that it can be processed by the DHCP message processor 211 of the DHCP spoofing server 21 (S2).

The DHCP message processor 211 which has received the DHCPDISCOVER message stores a MAC (media access control) address of the client PC 10 to be used as a destination MAC address when the DHCPOFFER message is transmitted to the client PC 10.

Next, like S3, a discovery stage 242 of a PPPoE layer 24 is executed so that a PPP session can be produced between the xDSL modem 20 and the NAS 40.

The discovery stage 242 of the PPPoE layer 24 corresponds to “a” of FIG. 5, and includes PPPoE active discovery initiation (PADI), PPPoE active discovery offer (PADO), PPPoE active discovery request (PADR), and PPPoE active discovery session confirmation (PADS) as described in RFC2516.

As the discovery stage 242 is executed, a connection to the NAS 40 is established through a physical layer to obtain the IP configuration information.

When the IP configuration information is obtained from the NAS 40, a PPP session stage 241 is executed through “b” of FIG. 5.

The PPP session stage 241 is a process of executing a PPP (point-to-point protocol) LCP (link control protocol) stage 234 process described in RFC1661 corresponding to “c” of FIG. 5.

When the PPP LCP stage 234 is executed and a link with a PPP layer of the NAS 40 is established, like “d” of FIG. 5, an authentication stage 233 is executed for user authentication.

At the PPP authentication stage 233, an encryption protocol described in RFC1334 such as a password authentication protocol (PAP), a challenge-handshake authentication protocol (CHAP), and an extensible authentication protocol (EAP) is used.

When the user authentication is completed through such an encryption process, a PPP IPCP (internet protocol control protocol) stage 232 described in RFC1332 is executed.

The PPP IPCP stage 232 is a stage of obtaining actual IP configuration information (global IP address, gateway IP address, domain name system (DNS) server IP address) which is to be used by the client PC 10.

At this time, to obtain values of domain name system (DNS) servers which are option fields, a configure-request message which additionally contains an IPCP option 81 (first domain name system (DNS) address) and an IP option 83 (second domain name system (DNS) address) is transmitted to the NAS 40.

The IP configuration information obtained from the NAS 40 through the PPP connection is as follows:

Local IP address: a global IP address that the NAS allocates to the client PC;

Remote IP address: an IP address of the NAS to be used as a gateway IP address by the client PC; and

domain name system (DNS) server address: an IP address for domain name system (DNS) server.

The IP configuration information obtained from the NAS 40 through the PPP IPCP stage 232 is transmitted to the DHCP message processor 211 to be used by the DHCP spoofing server 21 like “f” of FIG. 5.

The DHCP message processor 211 of the DHCP spoofing server 21 produces the DHCPOFFER message which is a response message to the DHCPDISCOVER message transmitted from the client PC. The IP configuration information contained in the DHCP OFFER message has a global IP address, a gateway IP address, a domain name system (DNS) server IP address, a lease time, a lease renewal time, and a subnet mask obtained from the NAS.

However, the IP configuration information obtained from the NAS through the PPP connection does not includes the subnet mask, and thus should produce it by itself using the global IP address and the gateway IP address.

A function to produce the subnet mask is shown in Table 1.

```
TABLE
for(int n_count=31; n_count > 0 ; n_count−−{
  if((Global_IP_Address [symbol] n_count)!=(Gateway_IP_Address [symbol] n_count)){
      n_count++;
      break;
  }
}
subMask = (0xFFFFFFFF [symbol] n_count );
subMask = (subMask [symbol] n_count );
```

Like S4 of FIG. 5, the DHCPOFFER message is transmitted to a header producing unit 212 and is produced to a frame containing an UDP (user datagram protocol) header, an IP header, and an Ethernet header added in the header producing unit 212 and then is transmitted to the Ethernet layer 22.

At this time, a destination IP address becomes an IP address to be allocated to the client PC, and a private IP address is used as a source IP address field.

A destination MAC address uses a MAC address of the client PC 10 reserved in the DHCP message processor 211 when the DHCPDISCOVER message is received, and a MAC address of the xDSL modem 20 is used as a source MAC address.

The DHCPOFFER message completed in the above described process is transmitted to the Ethernet layer 22 to be transmitted to the client PC 10 like S5 of FIG. 5.

The client PC 10 receives the DHCPOFFER message and transmits a DHCPREQUEST message to the XDSL modem 20, and the DHCPREQUEST message is received and processed by the DHCP message processor 211 of the DHCP spoofing server 21 through S1 and S2 of FIG. 5.

The DHCP message processor 211 loads the IP configuration information on the DHCPACK message which is a confirmation message for the DHCPREQUEST message and transmits it to the client PC 10 through S4 and S5.

The client PC 10 which has received the DHCPACK message containing the IP configuration information received from the xDSL modem 20 installs the IP configuration information in a corresponding file to connect to the NAS 40.

The client PC 10 obtains the IP configuration information from the NAS 40 through the above described process, so that a TCP/IP connection between the client PC 10 and the XDSL modem 20 is established, and a PPP connection between the xDSL modem 20 and the NAS 40 is established.

As described above, after the client PC 10 is allocated the IP address from the DHCP spoofing server 21 of the xDSL modem 20, the connection between the client PC 10 and the NAS 40 is established.

Meanwhile, if an installer sets an ID (identification) and a password for the client PC in the xDSL modem when the xDSL modem is installed, the user of the client PC does not need to input the ID and the password to connect to the Internet. The ID and the password can be set and changed by the user.

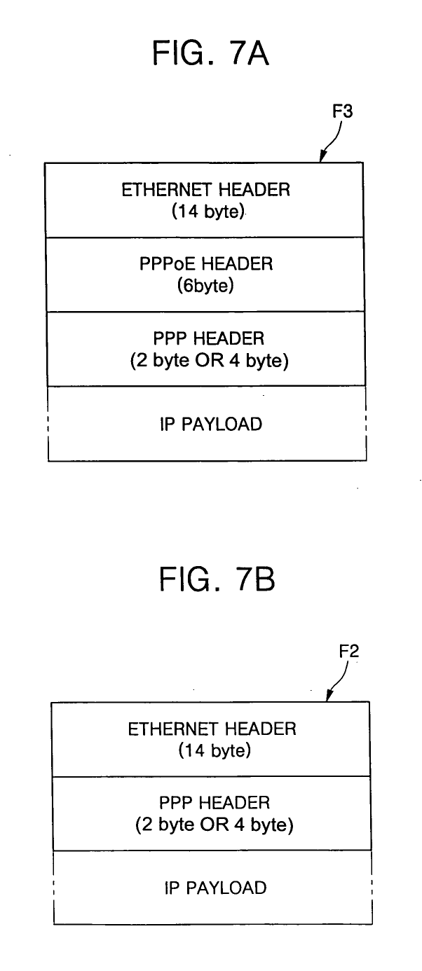

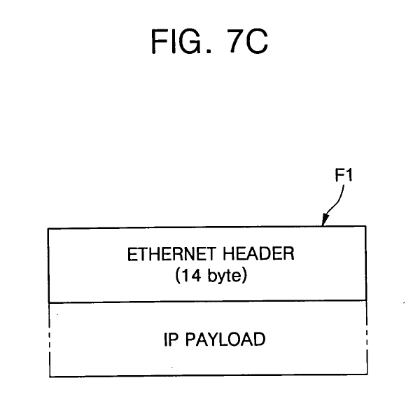

Hereinafter, a data frame format which is transmitted from the client PC 10 to the NAS 40 through the xDSL modem 20 is explained with reference to FIG. 5 and FIGS. 7a to 7c.

FIG. 7a is a diagram illustrating a frame format in a PPPoE layer, FIG. 7b is a diagram illustrating a frame format in a PPP layer, and FIG. 7c is a diagram illustrating a frame format in an Ethernet layer.

In the xDSL modem 20, a data frame is transmitted to a PHAD 231 of the PPP layer 23 through the Ethernet layer 22 like “h” of FIG. 5, and has a format of F1 of FIG. 7c.

At this time, a type field value of the Ethernet header is set to “0x0800” which means that a payload is an IP packet.

Thereafter, the data frame has a PPP header added thereto by the PHAD 231 of the PPP layer 23 and then is transmitted to the PPPoE layer 24 like “g” of FIG. 5. Therefore, the data frame has a format of F2 of FIG. 7b.

At this time, a size of the PPP header is 2 bytes in a standard PPP and has a value of “0xC021”.

Then, the data frame has a PPPoE header added thereto in the PPPoE layer 24 like F3 of FIG. 7a and is transmitted to the NAS 40 through an ATM layer 25 which is a physical layer like “b” of FIG. 5.

At this time, in the frame format in the PPPoE layer 24, a type field of the Ethernet header is set to “0x8864” which means that a payload is a PPPoE. A code field of the PPPoE header is set to “0x00”, and a session ID filed is set to a value allocated in a discovery process.

Also, a length field denotes a PPPoE payload length, and a length of an Ethernet header or a PPPoE header is not included.

In contrast, a frame transmitted to the client PC 10 from the NAS 40 through the xDSL modem 20 is transmitted to the PPPoE layer 24 through the ATM layer 25 which is a physical layer of the xDSL modem 20 like “b” of FIG. 5. At this time, the data frame has a format of F3 of FIG. 7a.

The PPPoE header is deleted from the data frame F3 in the PPPoE layer 24, and then the data frame is transmitted to the PPP layer 23 like “g” of FIG. 5. At this time, the data frame has a format of F2 of FIG. 7b.

Then, the PPP header is deleted from the data frame F2 in the PHAD 231 of the PPP layer 23, and the data frame having a format of F1 of FIG. 7c is transmitted to the Ethernet layer 22 like “h” of FIG. 5.

As described above, when the user turns off the client PC or deletes the IP configuration information to inactivate a LAN (local area network) port after the transmission and reception of an IP packet is carried between the client PC 10 and the NAS 40, a process of returning an IP address to the NAS is performed.

First, when the xDSL modem 20 returns the IP address allocated through the PPP connection to the NAS, there may be a case that a DHCPRELEASE message is received from the client PC 10 or a DHCPREQUEST message for a renewal request is not received from the client PC 10 during a lease time that the DHCP spoofing server 21 of the XDSL modem 20 has allocated to the client PC 10 at the initial stage.

In this case, the DHCP spoofing server 21 of the xDSL modem 20 informs the LCP stage 234 of the PPP layer 23 of a return of the IP address.

The LCP stage 234 transmits a termination request message (Terminate-Request message) to the PPPoE layer 24 through “c” of FIG. 5, and the PPPoE layer 24 transmits it to the NAS 40 through “b” of FIG. 5.

The NAS 40 that has received the termination request message transmits a termination ACK (acknowledgement) message to the xDSL modem 20 and releases an established PPP link.

Therefore, the NAS 40 can allocate to other xDSL modems an IP address allocated to the XDSL modem 20 which has transmitted the termination request message.

Also, after transmitting the termination request message to the NAS 40, the LCP stage 234 informs the PPPoE layer 24 of release of the PPP link to cut off the PPPoE session.

The PPPoE layer 24 transmits a PPPoE active discovery termination (PADT) packet to the NAS 40 through “a” of FIG. 5, thereby terminating the PPP session.

Through the processes described above, the client PC 10 returns the allocated IP address to the NAS 40.

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

As described above, according to the present invention, the digital subscriber line modem are provided with the PPPoE module, the PPP module and the DHCP spoofing server, and thus the Internet connection can be carried out without installing the PPPoE driver in the client terminal, whereby a user can reduce a cost for the PPPoE driver (Internet connection program).

Also, the communication carrier does not need to perform maintenance for the Internet connection program, and thus a service cost is reduced. Further, since the ID and the password are stored in the xDSL modem, the user can connect to the Internet without inputting the ID and the password, and thus there is no possibility that they are exposed to other persons. Furthermore, the communication carrier does not need to develop the Internet connection program.

While the invention has been particularly shown and described with reference to the preferred embodiments thereof, it will be understood by those skilled in the art that the foregoing and other changes in form and details may be made therein without departing from the spirit and scope of the invention.

1. A method of connecting to the Internet using a Digital Subscriber Line modem of a Point-to-Point Protocol over Ethernet method which supports a Point-to-Point Protocol over Ethernet connection between a client terminal and a Network Access Server, comprising:
connecting between said digital subscriber line modem and said Network Access Server through a Point-to-Point Protocol method and connecting between said Digital Subscriber Line modem and said client terminal through a Transmission Control Protocol/Internet Protocol method;
at said client terminal, obtaining Internet protocol configuration information from said network access server through said digital subscriber line modem; and
at said digital subscriber line modem, bridging a point-to-point protocol network and a transmission control protocol/Internet protocol network so that an Internet protocol packet is transmitted between said network access server and said client terminal.

2. The method of claim 1, further comprising of returning, to said network access server an Internet Protocol address which is allocated when said client terminal connects to the Internet.

3. The method of claim 1, wherein obtaining said Internet protocol configuration information includes:
executing a dynamic host configuration protocol client mounted on said client terminal to drive a dynamic host configuration protocol spoofing server installed in said digital subscriber line modem;
at said dynamic host configuration protocol spoofing server, executing a discovery stage to obtain said Internet protocol configuration information from said network access server;
obtaining said Internet protocol configuration information by said discovery stage; and
at said client terminal, setting the obtained Internet protocol configuration information in a corresponding file.

4. The method of claim 3, wherein driving said dynamic host configuration protocol spoofing server is performed through a step of, at said dynamic host configuration protocol client installed in said client terminal, broadcasting a message to obtain said Internet protocol configuration information allocated from said dynamic host configuration protocol server.

5. The method of claim 3, wherein executing said discovery stage includes:
executing a point-to-point protocol session stage with said network access server;
executing a point-to-point protocol Internet protocol control protocol to obtain said Internet protocol configuration information from said network access server when said point-to-point protocol session stage is performed and a point-to-point protocol link is established; and
obtaining said Internet protocol configuration information from said network access server by a Internet protocol control protocol stage.

6. The method of claim 3, further comprising, after said Internet protocol configuration information to be used by said client terminal is obtained by obtaining said Internet protocol configuration information by said discovery stage,
transmitting to a dynamic host configuration protocol message processor of said dynamic host configuration protocol spoofing server;
at said dynamic host configuration protocol message processor, producing a response message for an Internet protocol configuration information request message broadcasted by said client terminal and transmitting said message to a header producing unit;
transmitting to an Ethernet driver in said form of a frame having an Internet protocol header and an Ethernet header produced in said header producing unit;
at said client terminal, transmitting said response message for said Internet protocol configuration information request message to said dynamic host configuration protocol message processor; and
at said dynamic host configuration protocol message processor, loading to a confirm message for said Internet protocol configuration information response message and transmitting to said client terminal.

7. The method of claim 1, wherein said Internet protocol configuration information includes an Internet protocol address, a gateway address, a subnet mask, a domain name system server Internet protocol address, a lease time, and a lease renewal time.

8. The method of claim 3, further comprising storing a media access control address of said client terminal, which is to be used when a dynamic host configuration protocol offer message is transmitted, by said dynamic host configuration protocol message processor which has received a message broadcasted from said dynamic host configuration protocol client.

9. The method of claim 4, further comprising, storing a media access control address of said client terminal, which is to be used when a dynamic host configuration protocol offer message is transmitted, by said dynamic host configuration protocol message processor which has received a message broadcasted from said dynamic host configuration protocol client.

10. The method of claim 3, wherein said discovery stage step of a point-to-point protocol over ethernet layer includes a point-to-point protocol over ethernet active discovery initiation step, a point-to-point protocol over ethernet active discovery offer step, a point-to-point protocol over ethernet active discovery request step, and a point-to-point protocol over ethernet active discovery session confirmation step.

11. The method of claim 5, wherein said discovery stage step of a point-to-point protocol over ethernet layer includes a point-to-point protocol over ethernet active discovery initiation step, a point-to-point protocol over ethernet active discovery offer step, a point-to-point protocol over ethernet active discovery request step, and a point-to-point protocol over ethernet active discovery session confirmation step.

12. The method of claim 5, wherein said point-to-point protocol session step includes:
a point-to-point protocol link control protocol step of executing a link with a point-to-point protocol layer of said network access server;
an authentication step of performing a user authentication process; and
an Internet protocol control protocol step of performing a process for obtaining said Internet protocol configuration information which is to be used by said client terminal, after said authentication is completed.

13. The method of claim 12, wherein said authentication step is one of a password authentication protocol, a challenge-handshake authentication protocol, and an extensible authentication protocol.

14. The method of claim 5, wherein said point-to-point protocol session step includes a point-to-point protocol header addition and deletion step of producing a point-to-point protocol header when a frame is transmitted to a point-to-point protocol layer from an Ethernet layer, and deleting said point-to-point protocol header when said frame is transmitted to said Ethernet layer from said point-to-point protocol layer.

15. The method of claim 12, wherein said point-to-point protocol session step includes a point-to-point protocol header addition and deletion step of producing a point-to-point protocol header when a frame is transmitted to a point-to-point protocol layer from an Ethernet layer, and deleting said point-to-point protocol header when said frame is transmitted to said Ethernet layer from said point-to-point protocol layer.

16. The method of claim 1, wherein bridging said point-to-point protocol network and said transmission control protocol/Internet protocol network includes:
when a frame is transmitted to said network access server from said client terminal through said digital subscriber line modem, said frame having an Ethernet header added to a packet corresponding to actual data is transmitted to a point-to-point protocol layer through a transmission control protocol/Internet protocol driver;
transmitting said frame having a point-to-point protocol header added thereto in said point-to-point protocol layer to a point-to-point protocol over ethernet layer; and
transmitting said frame having a point-to-point protocol over ethernet header added thereto in said point-to-point protocol over ethernet layer to a physical layer,
wherein said frame includes a payload corresponding to said actual data, said point-to-point protocol over ethernet header, said point-to-point protocol over ethernet header, and said Ethernet header.

17. The method of claim 1, wherein bridging said point-to-point protocol network and said transmission control protocol/Internet protocol network includes:
when a frame is transmitted to said client terminal from said network access server through said digital subscriber line modem, transmitting said frame having a payload corresponding to actual data, a point-to-point protocol header, a point-to-point protocol over ethernet header, and an Ethernet header to a point-to-point protocol over ethernet layer;
deleting said point-to-point protocol over ethernet header from said frame in a point-to-point protocol over ethernet module and transmitting said frame having said payload corresponding to said actual data, said point-to-point protocol header, and said Ethernet header to a point-to-point protocol layer; and
deleting said point-to-point protocol header from said frame in said point-to-point protocol layer and transmitting to said Ethernet layer,
wherein a packet is transmitted in a form of said payload corresponding to said actual data and said Ethernet header.

18. The method of claim 16, wherein in a frame format in said point-to-point protocol over ethernet layer, a type field of said Ethernet header is set to represent that said payload is a point-to-point protocol over ethernet, a code field of said point-to-point protocol over ethernet header is “0x00”, a session identification field is set to a value allocated in a discovery process, and a length field is set to represent a point-to-point protocol over ethernet payload length.

19. The method of claim 17, wherein in a frame format in said point-to-point protocol over ethernet layer, a type field of said Ethernet header is set to represent that said payload is a point-to-point protocol over ethernet, a code field of said point-to-point protocol over ethernet header is “0x00”, a session identification field is set to a value allocated in a discovery process, and a length field is set to represent a point-to-point protocol over ethernet payload length.

20. The method of claim 1, wherein returning said Internet protocol address to said network access server includes:
when a dynamic host configuration protocol release message is received from said client terminal or a dynamic host configuration protocol spoofing server of said digital subscriber line modem does not receive a renewal request message from said client terminal within a lease time allocated to said client terminal,
at said dynamic host configuration protocol spoofing server, informing a link control protocol stage of a point-to-point protocol layer of an Internet protocol address return;
at said point-to-point protocol link control protocol stage, transmitting a termination request message to a point-to-point protocol over ethernet layer;
at said point-to-point protocol over ethernet layer, transmitting said termination request message to said network access server through a physical layer; and
at said network access server, transmitting a termination acknowledge message to said digital subscriber line modem to release an established point-to-point protocol link.

21. The method of claim 20, wherein when said dynamic host configuration protocol release message is received from said client terminal, this means that said client terminal is turned off or said user deletes said Internet protocol configuration information so that a local area network port of said client terminal becomes inactivated.

22. The method of claim 20, further comprising,
when said termination request message is transmitted to said network access server, at said point-to-point protocol link control protocol stage, informing said point-to-point protocol over ethernet layer of release of said point-to-point protocol link to cut off said point-to-point protocol over ethernet session; and
at said point-to-point protocol over ethernet layer, transmitting a point-to-point protocol over ethernet active discovery termination packet to said network access server to terminate said point-to-point protocol session.

23. A digital subscriber line modem with a dynamic host configuration protocol spoofing server, comprising:
a dynamic host configuration protocol spoofing server module for performing said same function as a dynamic host configuration protocol server;
a point-to-point protocol module for providing a point-to-point protocol connection with a network access server; and
a point-to-point protocol over Ethernet module for connecting to a client terminal through an Ethernet protocol and supporting said point-to-point protocol connection with said network access server.

24. The modem of claim 23, wherein when said client terminal is booted, a transmission control protocol/Internet protocol connection is established between said client terminal and a digital subscriber line modem and a point-to-point protocol connection is established between said digital subscriber line modem and said network access server such that said digital subscriber line modem connects to said network access server through a point-to-point protocol method to obtain Internet protocol configuration information and then provides said obtained Internet protocol configuration information to said client terminal through a dynamic host configuration protocol message.

25. The modem of claim 23, further comprising a point-to-point protocol header addition/deletion unit which adds a point-to-point protocol header to a data frame when an Internet protocol packet is transmitted to said network access server from said client terminal, and deletes said point-to-point protocol header of said data frame when said Internet protocol packet is transmitted to said client terminal from said network access server.

26. The modem of claim 23, wherein a subnet mask is produced from a gateway Internet protocol address and a global Internet protocol address among said Internet protocol configuration information obtained from said network access server.

27. An Internet connection system for performing Internet connection through a digital subscriber line modem, comprising:
at least one client terminal connecting to said digital subscriber line modem through a transmission control protocol/Internet protocol connection;
a network access server connecting to said digital subscriber line modem through a point-to-point protocol connection; and
said digital subscriber line modem including a dynamic host configuration protocol spoofing server module for performing said same function as a dynamic host configuration protocol server, a point-to-point protocol module for providing said point-to-point protocol connection with a network access server, and a point-to-point protocol over Ethernet module for connecting to said client terminal through an Ethernet protocol and supporting said point-to-point protocol connection with said network access server.

28. The modem of claim 27, wherein when said client terminal is booted, said transmission control protocol/Internet protocol connection is established between said client terminal and said digital subscriber line modem and said point-to-point protocol connection is established between said digital subscriber line modem and said network access server such that said digital subscriber line modem connects to said network access server through a point-to-point protocol method to obtain Internet protocol configuration information and then provides said Internet protocol configuration information to said client terminal through a dynamic host configuration protocol message.

29. The modem of claim 27, further comprising a point-to-point protocol header addition/deletion unit which adds a point-to-point protocol header to a data frame when an Internet protocol packet is transmitted to said network access server from said client terminal, and deletes said point-to-point protocol header of said data frame when said Internet protocol packet is transmitted to said client terminal from said network access server.

30. The modem of claim 27, wherein a subnet mask is produced from a gateway Internet protocol address and a global address among said Internet protocol configuration information obtained from said network access server.

31. A computer-readable medium having computer-executable instructions for performing a method, comprising:
connecting between a digital subscriber line modem and a Network Access Server through a Point-to-Point Protocol method and connecting between a Digital Subscriber Line modem and said client terminal through a Transmission Control Protocol/Internet Protocol method;
at said client terminal, obtaining Internet protocol configuration information from said network access server through said digital subscriber line modem; and
at said digital subscriber line modem, bridging a point-to-point protocol network and a transmission control protocol/Internet protocol network so that an Internet protocol packet is transmitted between said network access server and said client terminal.
